(19) United States
(12) Patent Application Publication
(10) Pub. No.: US 2010/0085652 A1
(43) Pub. Date: Apr. 8, 2010

(54) ADJUSTABLE VEHICLE MIRROR APPARATUS

(76) Inventor: Michael Crouse, Sylvania, OH (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 12/575,540

(22) Filed: Oct. 8, 2009

Related U.S. Application Data
(60) Provisional application No. 61/103,711, filed on Oct. 8, 2008.

(51) Int. Cl. G02B 7/198

(52) U.S. Cl. 359/843

(57) ABSTRACT

An automatic mirror adjustment mechanism includes a side rear view mirror mounted on a drivable vehicle. The drivable vehicle has a trailer pivotally mounted thereto. A sensor is mounted on the drivable vehicle, wherein the sensor is configured to determine the distance between the drivable vehicle and the trailer. A control mechanism adjusts the position of the rear view mirror based on the change in distance between the drivable vehicle and the trailer.

### CROSS-REFERENCE TO RELATED APPLICATIONS

This application claims the benefit of U.S. Provisional Application No. 61/103,711 filed Oct. 8, 2008, the disclosure of which is incorporated herein by reference.

### BACKGROUND OF THE INVENTION

This invention relates in general to an adjustable rear view mirror for a vehicle, and more particularly to adjusting the passenger-side rear view mirror for a tractor trailer type vehicle.

### SUMMARY OF THE INVENTION

This invention relates to an adjustable rear view mirror apparatus wherein at least one of the rear view mirrors is adjusted based on the articulation between a trailer and a tractor.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a plan view of a tractor trailer vehicle in a substantially aligned position.

FIG. 2 is a plan view of the tractor trailer vehicle of FIG. 1 with the trailer angled relative to the tractor.

FIG. 3 is an enlarged plan view of the tractor trailer vehicle shown in FIG. 1 having the automatic mirror adjustment apparatus according to the present invention.

FIG. 4 is an enlarged plan view of the tractor trailer vehicle shown in FIG. 2 having the automatic mirror adjustment apparatus according to the present invention.

### DETAILED DESCRIPTION OF THE PREFERRED EMBODIMENT

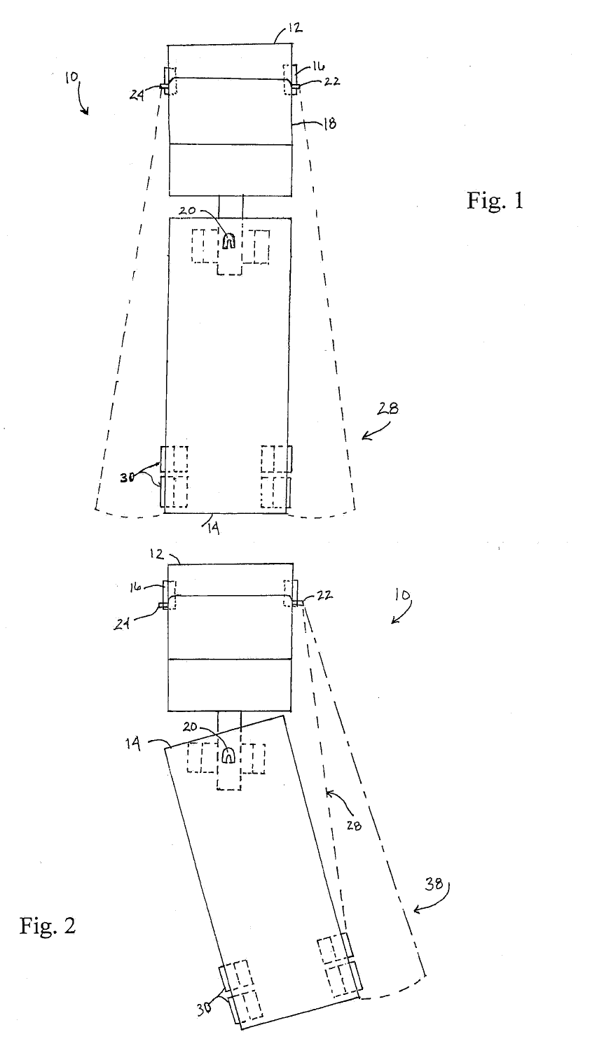

Vehicles such as tractor trailers are well known in the art. For the purposes of the present invention, any vehicle having a trailer pivotally connected to a drivable vehicle can incorporate an automatic mirror adjustment apparatus according to the present invention without departing from the spirit or scope of the invention. Referring now to the drawings, there is illustrated in FIG. 1 a top view of a tractor trailer vehicle 10 having an independently drivable tractor 12 and a pivotable trailer 14 connected to the tractor 12. As is conventionally known, the tractor 12 is independently drivable from the trailer 14 and, therefore, includes a powertrain system, an independent suspension system (not shown) having a plurality of drivable wheels 16, a passenger seating compartment 18, and a hitch mechanism 20. Although the wheels 16 are shown, it should be appreciated that any number, style, type and configuration of the wheels 16 can be used with the tractor 12 as is known in the art. The hitch mechanism 20 provides a mechanism for the attachment of the trailer 14 to the tractor 12 as well as allowing the trailer 14 to pivot or articulate relative to the tractor 12. Typically, when the vehicle 10 is being driven along a substantially straight path, the angle along the length of the tractor 12 and the trailer 14 is approximately 180 degrees. Also shown in FIG. 1 are a pair of rear view mirrors 22 and 24. A passenger side rear view mirror (a first mirror) 22 is positioned on the exterior of the tractor 12 adjacent the passenger compartment 18 on the passenger side of the vehicle 10. A similar driver side rear view mirror (a second mirror) 24 is positioned on the exterior of the tractor 12 adjacent the passenger compartment 18 on the driver side of the vehicle 10. It should be appreciated that the mirrors 22 and 24 can be positioned anywhere on the tractor 12 as long as they are viewable by the operator of the tractor 12 and the mirrors 22 and 24 reflect an image of an area that is rearward of the mirrors 22 and 24. Particularly, the rearward field of vision is defined by a driver side field of vision 26 and a passenger side field of vision 28.

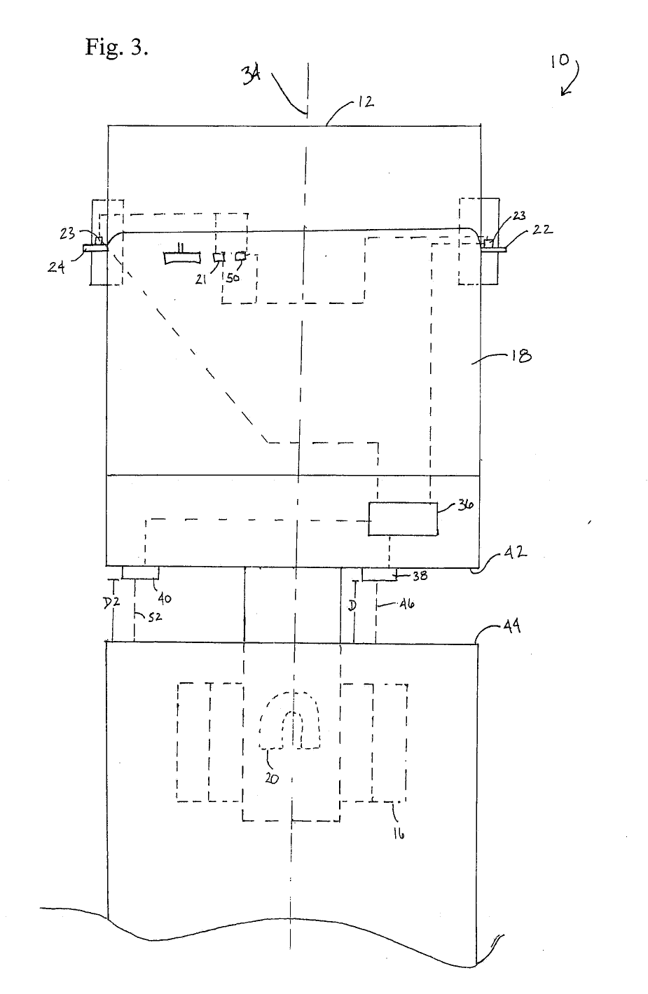

The mirrors 22 and 24 of the vehicle 10 are typically manually or electronically adjustable by a vehicle operator and are so positioned prior to, or during operation of the vehicle 10. Preferably, the operator adjusts the position of the mirrors 22 and 24 prior to driving the vehicle 10 such as would occur during a pre-trip inspection. A pre-trip inspection increases the vehicle operating safety so the driver does not have to adjust the mirrors 22 and 24 while driving the vehicle 10. As is known in the art, such mirrors 22 and 24 can be electronically controlled from within the passenger compartment 18 by a switch or switches (indicated at 21 in FIG. 3) that allow the vehicle operator to change the angle of the mirror in a plurality of axes. The use of a motorized control mechanism for controlling the electronically operated mirror adjustment mechanism is generally known in the art. One example of such a mirror adjustment mechanism is disclosed in U.S. Pat. No. 4,519,677 to Weber et al., the disclosures of which are incorporated herein in their entirety by reference. As will be described below, the mirror adjustment mechanisms 23 can be adapted to cooperate with the automatic mirror adjustment apparatus 35 according to the present invention. The vehicle operator ideally positions the mirrors 22 and 24 to allow the operator to maximize the field of vision on either side of the vehicle 10. There are fields of vision on both sides of the tractor 12 in a rearward direction relative to the tractor 12 as shown in FIG. 1. The driver side field of vision 26 and the passenger side field of vision 28 are indicated generally in FIG. 1. The fields of vision 26 and 28 will vary according to the position of the operator of the tractor 12 and the position of the mirrors 22 and 24. However, the fields of vision 26 and 28 shown in FIG. 1 indicate the generally rearward viewable area for an operator that is within the passenger compartment 18 of the tractor 12. The positions of the mirrors 22 and 24 are automatically adjustable to increase the operator's field of vision during operation of the vehicle 10 as will be described in greater detail below.

As stated above, the trailer 14 is pivotally attached to the tractor 12 via the hitch mechanism 20. The specific manner in which the trailer 14 is connected to the hitch mechanism 20 of the tractor 12 will vary depending on the specific type of vehicle. Such hitch mechanisms 20 are generally known in the art. The illustrated trailer 14 includes a plurality of wheels 30. It should be appreciated that the trailer 14 can also include any number, size, type and configuration of wheels 30 depending on the type of trailer 14 and its intended use. The wheels 30 of the trailer 14 typically are not drivable wheels in that those wheels 30 are not operated by the suspension system of the tractor 12. Therefore, the wheels 30 of the trailer 14 rotate freely when the attached tractor 12 is being driven. However, as is also known, the trailer wheels 30 typically do not substantially pivot like the drivable wheels 16 on the tractor 12. The wheels 16 of the tractor 12 pivot to steer the vehicle 10 as controlled by a steering mechanism, such as a steering wheel and suspension system. A cargo portion of the trailer 14 can have any suitable structure. A typical trailer 14 used with a tractor 12 is a box type structure defining a large cavity so that the inner compartment of the box can be used to transport various large items. Also, a trailer 14 can have a flat bed suitable for carrying items that do not easily fit within a box compartment. It should be appreciated that any type of trailer can be used in conjunction with the present invention.

Illustrated in FIG. 2, the vehicle 10 is shown in a right turning position. As can also be seen, the passenger side field of vision 28 in a rearward direction is substantially reduced if the operator were to look into an unadjusted second mirror 22 to see that which is rearward of the tractor 12 in order to safely maneuver the vehicle 10. This obstructed field of vision 28 is more of a problem when the vehicle 10 is being moved in reverse. The operator of the vehicle 10 is often required to move the vehicle 10 in reverse to back up to a loading dock or to park the vehicle 10, or otherwise move in reverse. However, maintaining a clear field of vision 28 is also beneficial while moving forward and turning. When moving forward, the trailer 14 can obstruct the field of vision 26 of the operator depending on the direction of the turn. As shown in FIG. 2, the field of vision 26 on the passenger side of the vehicle 10 is obstructed when the angle between the tractor 12 and trailer 14 becomes less than 180 degrees (such as when the vehicle 10 is turned to the right or is backing to the right as shown in FIG. 2). The greater the angle of the turn, regardless of whether the vehicle 10 is moving forward or backward, the more the field of vision would be reduced. It should be appreciated that an obstructed field of vision occurs when the angle of the mirror 22 relative to the tractor 12 remains in a stationary position (such as with prior art rear view mirrors). According to the present invention, the passenger side field of vision 28 will not become obstructed due to the adjustable vehicle mirror apparatus 35 described below. The passenger side field of vision that is visible using the automatic mirror adjustment apparatus 35 according to the present invention is indicated generally in FIG. 2 at 32.

Illustrated in FIG. 3, there is shown an enlarged top view of the vehicle 10 and more particularly, the area of the vehicle 10 where the tractor 12 and vehicle 14 are pivotally mounted relative to each other at the hitch mechanism 20. The vehicle 10 is shown in a generally straight position in this view. Illustrated in FIG. 3, there is shown a centerline 34 passing substantially through the center of the vehicle 10 along a longitudinal axis. The vehicle 10 is substantially symmetrical about the centerline 34. The vehicle 10 includes an automatic vehicle mirror adjustment apparatus 35 according to the present invention. In the preferred embodiment, the automatic vehicle mirror adjustment apparatus 35 includes a control unit, shown generally at 36, that is preferably mounted within the tractor 12. The control unit 36 is connected to one of, or both, the first mirror 22 and the mirror adjustment mechanism 23 to detect and control the position of the mirror 22. The control unit 36 can also be connected to one of or both, the second mirror 24 and the mirror adjustment mechanism 23. The control unit 36 is also preferably connected to a first sensor mechanism 38. The sensor mechanism 38 is preferably mounted to an exterior rear face 42 of the tractor 12. It is further preferred that the sensor 38 is mounted away from the centerline 34. As will become understood more with the following description, the turn direction of the tractor 12 relative to the trailer 14 can be more easily detected with the first sensor 38 located away from the centerline 34 versus being mounted on the centerline 34.

The sensor mechanism 38 is preferably a mechanism such as a laser range sensor. Laser range sensors are generally known in the art. As applied to the automatic mirror adjustment apparatus 35 of the present invention, the sensor mechanism 38 is used to emit a beam of light, indicated generally at 46, on the front face 44 of the trailer 14. The beam of light 46 thereby illuminates a spot on the front surface 44 of the trailer 14. A beam of electromagnetic pulses that form the beam of light 46 illuminates the spot, which then reflects the light along a path substantially parallel to the beam 46. The laser range sensor 38 according to the present invention measures the round trip time of flight of the stream of light pulses. Based on the round trip time of the light beam, the distance, D, between the sensor 38 and the front face 44 of the trailer 14 can be determined. One example of a laser range sensor that can be modified to work with the present invention can be found in U.S. Pat. No. 5,767,953 to McEwan (hereinafter McEwan), the disclosures of which are incorporated herein in their entirety by reference. It should be appreciated that the modifications necessary to make the laser range finder shown in McEwan work with the automatic mirror adjustment apparatus 35 according to present invention will be evident to those skilled in the art. The distance that is determined by the sensor 38 is preferably transmitted to the control unit 36.

Described next is the operation of the automatic mirror adjustment apparatus 35. As was described above, the operator adjusts the position of the mirrors 22 and 24 prior to the vehicle 10 operation using the switch 21 to operate the mirror adjustment mechanism 23. Preferably the operator adjusts the positions of the mirrors 22 and 24 while the tractor 12 and trailer 14 are substantially aligned with the centerline 34. Once the operator has adjusted the mirrors 22 and 24 (such as during a pre-trip inspection), the operator actuates a switch 50. Actuation of the switch 50 sends a signal to the control unit 36. The control unit 36 detects the position of the mirrors 22 and 24 and the distance between the rear face 42 of the tractor 12 and the front face 44 of the trailer 14. This information defines the initial position information. This information is stored in a storage device within the control unit 36. The storage unit can be any suitable electronic storage device such as a hard drive, Flash memory card, RAM chip, or ROM chip. The position of the mirrors 22 and 24 can be based on any number of parameters including the angle of the mirror relative to a substantially horizontal plane and the angle of the mirror relative to a substantially horizontal plane. Alternatively, or additionally, since the position of the mirrors 22 and 24 is controlled electronically, the position of the mirrors 22 and 24 can be determined based on the position of a motor (not shown) that is a part of the mirror adjustment mechanism 23 used to drive the mirrors 22 and 24 into position. It should be appreciated that any suitable mechanism can be used to determine the position of the mirrors 22 and 24.

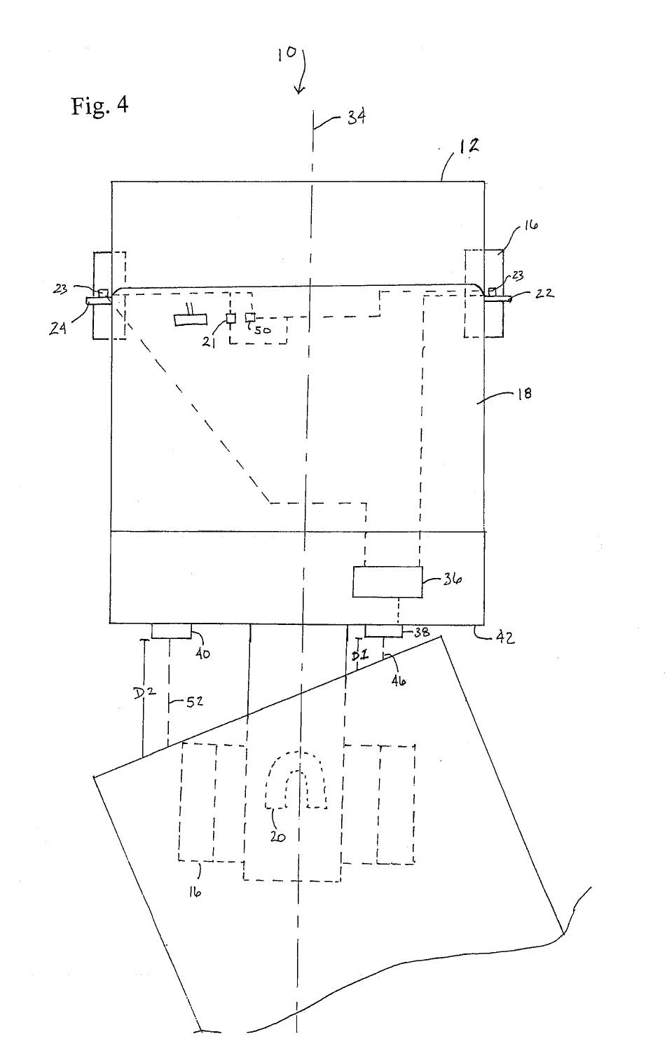

During operation of the vehicle 10, particularly when the vehicle is being operated to make a turn, the distance, D, of the path will change. As shown in FIG. 4, the trailer 14 is pivoted relative to the tractor 12 such as would occur during an operation where the vehicle 10 is being driven in reverse with the trailer 14 being turned to the right. When the vehicle 10 is in such a position, the distance, D1 of the path of the beam of light 46 will be reduced compared to the initial path distance, D, shown in FIG. 3. Therefore, the control unit 36 will receive a signal that indicates that this portion of the stored initial position information has changed and by how much. The control unit 36 preferably includes a central processing unit or CPU that can utilize an algorithm or look up table, or any other suitable determination method, to determine whether the vehicle 10 is turning left or right. Depending on the direction of the turn, the CPU can direct the control unit 36 to output a signal to control the position of the mirror 22 (or mirrors 22 and 24) using the mirror adjustment mechanism 23 depending on the direction of the turn. The control unit 36 would emit a signal to the mirror adjustment mechanism 23 for the first mirror 22 (for a right turn) to change the position of the first mirror 22 to create a field of view that prevents an obstructed view from occurring. With a right turn, the first mirror 22 would pivot further away from the passenger compartment 18 so as to expand the viewing area to the right of the tractor 12. The mirror 22 will adjust in an amount as directed by the controller 36. In the preferred embodiment, an algorithm or look up table can be used to adjust the position of the mirror 22 depending on the change in the distance (D-D1). For example, an algorithm can calculate the change in distance, compute a change in angle and output an angle change value that quantifies the amount the mirror is to be adjusted. Alternatively, a look up table could include specific values indicating that a distance change (D-D1) of 0 to 2 inches requires an angle change of 1 degree, a distance change of 2.1 to 4 inches requires and angle change of 3 degrees, etc. It should be understood that these examples are for illustration purposes only and that the distance changes and adjustment angles can have any desired values.

It should be appreciated that a second sensor 40 could be mounted on the exterior rear face 42 of the tractor 12 on the opposite side of the centerline 34 so that the automatic mirror adjustment apparatus 35 can be used to measure more precisely the distance, D2, of a path of a second beam of light 52 between the rear face 42 of the tractor 12 and the front face 44 of the trailer 14. However, it should be appreciated that the first sensor 38 can measure both increases and decreases in the path 48 length and send signals to the control unit 36 to control the position of both mirrors 22 and 24. The use of the second sensor 40 can also be used to determine whether the vehicle 10 is taking a right turn or a left turn. For example, if the first sensor 38 detects a distance between the rear face 42 of the tractor 12 and the front face 44 of the trailer 14 being reduced while the second sensor 40 detects a distance between the rear face 42 of the tractor 12 and the front face 44 of the trailer 14 being increased, the control unit 36 would determine that the vehicle 10 is being turned to the right. The opposite would also be true.

As can be appreciated by those skilled in the art, many tractors 12 can be used with a plurality of different trailers 14. For example, one tractor might pick up a first trailer at a first location, drive to a second location where the first trailer is dropped off and a second trailer is picked up to be transported to another location. Therefore, it can be appreciated that the sensors 38 and 40, and other components of the automatic mirror adjustment apparatus 35 are mounted on the tractor 12 so that the apparatus can operate with any trailer 14 that has a front face 44 upon which the light beams 46 and 52 can reflect. It should also be appreciated that the sensors 38 and 40 can be mounted at any position on or adjacent the rear face 42 of the tractor 12 so that it will be opposite a front face 44 of the trailer 14 so that there is a surface upon which the light beams 46 and 52 can reflect without interference from hoses, hydraulic lines, electrical wires, etc.

Although the present invention has been shown and described as being a tractor-trailer type vehicle, it should be appreciated that the present invention can also be used with any passenger vehicle (car, truck, sports utility vehicle, etc.) configured to tow a trailer. For example, many passenger vehicles are used to tow boats, campers, trailers, etc. Therefore, the operators of the passengers vehicles can utilize the present invention to control the position of the mirrors on the vehicles to increase the usable field of vision when the passenger vehicle is towing a trailer.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An automatic mirror adjustment mechanism comprising:
a side rear view mirror mounted on a drivable vehicle, the drivable vehicle having a trailer pivotally mounted thereto;
a sensor mounted on the drivable vehicle, wherein the sensor is configured to determine the distance between the drivable vehicle and the trailer; and
a control mechanism for adjusting the position of the rear view mirror based on the change in distance between the drivable vehicle and the trailer.
